(19) United States
(12) Patent Application Publication
(10) Pub. No.: US 2021/0355907 A1
(43) Pub. Date: Nov. 18, 2021

(54) STRUCTURE OF ELECTRICITY GENERATION BY OCEAN CURRENTS AND THE METHOD OF PLACING

(71) Applicant: NATIONAL TAIWAN UNIVERSITY, Taipei (TW)

(72) Inventor: FALIN CHEN, TAIPEI (TW)

(21) Appl. No.: 16/934,384

(22) Filed: Jul. 21, 2020

(30) Foreign Application Priority Data
May 18, 2020 (TW) 109116380

(51) Int. Cl. F03B 17/06; H02K 7/18

(52) U.S. Cl. CPC F03B 17/065; H02K 7/1823

(57) ABSTRACT

This invention is the structure of electricity generation by ocean currents and the method of placing with three-way connection device, turbo-generator device, suspension device, and anchor device. The turbo-generator device, suspension device and anchor device are respectively connected to the three-way connection device by the cable. Also, to fix the structure of electricity generation could be only required just one anchor device, which would significantly lower the cost of construction. Throughout the method of placing, the cantilever mechanical device is as a traction for the suspension device remain on the surface of water by the cable, after which, the three-way connection device, turbo-generator device and the suspension device will be sink to the bottom of the water with the anchor device after releasing the traction with the suspension device. Therefore, the structure of electricity generation by ocean currents and the method of placing are straightforward and easy.

### FIELD OF THE INVENTION

The present invention relates to an ocean-current power generation structure and the deployment method.

### BACKGROUND OF THE INVENTION

Approximately, three quarters of the area of the earth are ocean. Seawater is continuously in the flowing state and forming ocean currents with relatively stable flowing rate and direction. Thanks to its stable sources, no material consumption, and no pollution, this renewable energy source appeals attention. Many governments also start to invent technologies related to ocean-current power generation.

The ocean-current power generation technology adopts the kinetic energy of ocean currents to generate electric power. It is highly potential because ocean currents are regular and hence the energy can be predicted. In addition, the power generation is relatively stable over different periods; no ground is occupied; and the influence on ocean ecology is limited. According to the principle, ocean currents provide kinetic energy. Thereby, most ocean-current power generators adopts the design of rotating blades. The ocean currents rotate the blades and the spin shafts to generate electric power. Unfortunately, the ocean-current power generator must be fixed in the ocean, such as floating mooring, installation on the seabed, or anchoring on the sea floor, for not being rotated, tilted, or displaced by ocean currents. Nonetheless, the application of floating mooring in ocean-current power generation is relative immature; installation on the seabed is limited to shallower sea; and anchoring on the sea floor is costly. Consequently, the technologies are not widely adopted.

The present invention provides an ocean-current power generation structure and the deployment method. The structure is simple and the deployment method is easy. The structure is applicable to deep sea, shallow sea, or sea areas with stable currents. The time for construction is short and the cost is low.

### SUMMARY

An objective of the present invention is to provide an ocean-current power generation structure and the deployment method. The structure is simple and the deployment method is easy. The structure is applicable to deep sea, shallow sea, or sea areas with stable currents. The construction can be finished rapidly.

Another objective of the present invention is to provide an ocean-current power generation structure and the deployment method for further reducing anchor devices and thus lowering the construction cost.

To achieve the above objective, according to the first embodiment, the present invention provides an ocean-current power generation structure, which comprises a first tri-directional connecting device, a first turbine power generation device, a first buoyant device, and a first anchor device. The first turbine power generation device is connected to a first direction of the first tri-directional connecting device via a first cable. The first buoyant device is connected to a second direction of the first tri-directional connecting device via a second cable. The first anchor device is connected to a third direction of the first tri-directional connecting device via a third cable.

According to the second embodiment of the present invention, the first buoyant device includes a first rod on one side. The other side of the first rod is connected to a first omnidirectional connecting device.

According to the second embodiment of the present invention, the ocean-current power generation structure further comprises a second tri-direction connecting device, a second turbine power generation device, a second buoyant device, and a second anchor device. The second turbine power generation device is connected to the first direction of the second tri-directional connecting device via a fourth cable. The second buoyant device is connected to the second direction of the second tri-directional connecting device via a fifth cable. The second buoyant device includes a second rod on one side. The other side of the second rod is connected to the first omnidirectional connecting device. The second anchor device is connected to the third direction of the second tri-directional connecting device via a sixth cable.

According to the first and second embodiments of the present invention, the first buoyant device and the second buoyant device include an accommodating space such that the first buoyant device and the second buoyant device can be buoyant and floating on water. The first buoyant device and the second buoyant device can be selected from the group consisting of a sphere, a spheroid, and an aerofoil-shaped member.

According to the first and second embodiments of the present invention, the aerofoil-shaped member includes a first front edge, a first rear edge, a first top curved surface, and a first bottom curved surface. The first front edge shrinks gradually along the first top curved surface and the first bottom curved surface to the first rear edge.

According to the first and second embodiments of the present invention, the aerofoil-shaped member further includes an aileron, which includes a second front edge, a second rear edge, a second top curved surface, and a second bottom curved surface. The second front edge shrinks gradually along the second top curved surface and the second bottom curved surface to the second rear edge. The second front edge is connected to the first read edge via a second omnidirectional connecting device.

To achieve the above objective, according to the first embodiment, the present invention provides a deployment method for ocean-current power generation structure, which comprises steps of: connecting a first turbine power generation device to a first direction of a first tri-directional connecting device using a first cable; connecting a first buoyant device to a second direction of the tri-directional connecting device using a second cable; connecting a first anchor device to a third direction of the first tri-directional connecting device using a third cable; a cantilever mechanical device towing the first buoyant device using a seventh cable to a water surface; the cantilever mechanical device releasing the seventh cable used for towing the first buoyant device; and the first anchor device sinking the first tri-directional connecting device under the water surface, and the first turbine power generation device and the first buoyant device sinking concurrently.

According to the second embodiment of the present invention, after the step of connecting a first anchor device to a third direction of the first tri-directional connecting device using a third cable, the deployment method further comprises steps of: connecting a second turbine power generation device to the first direction of a second tri-directional connecting device using a fourth cable; connecting a second buoyant device to the second direction of the second tri-directional connecting device using a fifth cable; disposing a first rod on one side of the first buoyant device, disposing a second rod on one side of the second buoyant device, and connecting one side and the other side of a first omnidirectional connecting device to the first rod and the second rod, respectively; connecting a second anchor device to the third direction of the second tri-directional connecting device using a sixth cable; a cantilever mechanical device towing the first buoyant device using a seventh cable and the second buoyant device using an eighth cable to a water surface; the cantilever mechanical device releasing the seventh cable used for towing the first buoyant device and the eighth cable used for towing the second buoyant device; and the first anchor device and the second anchor device sinking the first tri-directional connecting device and the second tri-directional connecting device under the water surface, and the first turbine power generation device, the second turbine power generation device, the first buoyant device, and the second buoyant device sinking concurrently.

To achieve the other objective as described above, according to the first embodiment, the present invention provides an ocean-current power generation structure, which comprises a first tri-directional connecting device, a first turbine power generation device, a first buoyant device, a second tri-directional connecting device, a second turbine power generation device, a second buoyant device, a third rod, and a first anchor device. The first turbine power generation device is connected to a first direction of the first tri-directional connecting device via a first rope. The first buoyant device is connected to a second direction of the first tri-directional connecting device via a second rope. The first buoyant device includes a first rod on one side. The other side of the first rod is connected to a first omnidirectional connecting device. The second turbine power generation device is connected to the first direction of the second tri-directional connecting device via a third rope. The second buoyant device is connected to the second direction of the second tri-directional connecting device via a fourth rope. The second buoyant device includes a second rod on one side. The other side of the second rod is connected to the first omnidirectional connecting device. One side of the third rod is connected to the first tri-directional connecting device. The other side of the third rod is connected to the second tri-directional connecting device. The first anchor device is connected to the first tri-directional connecting device and a third direction of the second tri-directional connecting device via a fifth rope and a sixth rope.

According to the third embodiment of the present invention, the first buoyant device and the second buoyant device include an accommodating space such that the first buoyant device and the second buoyant device can be buoyant and floating on water. The first buoyant device and the second buoyant device can be selected from the group consisting of a sphere, a spheroid, and an aerofoil-shaped member.

According to the third embodiment of the present invention, the aerofoil-shaped member includes a first front edge, a first rear edge, a first top curved surface, and a first bottom curved surface. The first front edge shrinks gradually along the first top curved surface and the first bottom curved surface to the first rear edge.

According to the third embodiment of the present invention, the aerofoil-shaped member further includes an aileron, which includes a second front edge, a second rear edge, a second top curved surface, and a second bottom curved surface. The second front edge shrinks gradually along the second top curved surface and the second bottom curved surface to the second rear edge. The second front edge is connected to the first read edge via a second omnidirectional connecting device.

To achieve the other objective as described above, according to the third embodiment, the present invention provides a deployment method for ocean-current power generation structure, which comprises steps of: connecting a first turbine power generation device to a first direction of a first tri-directional connecting device using a first rope; connecting a first buoyant device to a second direction of the tri-directional connecting device using a second rope; connecting a second turbine power generation device to the first direction of a second tri-directional connecting device using a third rope; connecting a second buoyant device to the second direction of the second tri-directional connecting device using a fourth rope; disposing a first rod on one side of the first buoyant device, disposing a second rod on one side of the second buoyant device, and connecting one side and the other side of a first omnidirectional connecting device to the first rod and the second rod, respectively; connecting one side of a third rod to the first tri-directional connecting device, and connecting the other side of the third rod to the second tri-directional connecting device; connecting a first anchor device to the first tri-directional connecting device and a third direction of the second tri-directional connecting device using a fifth rope and a sixth rope; a cantilever mechanical device towing the first buoyant device using a seventh rope and the second buoyant device using an eighth rope to a water surface; the cantilever mechanical device releasing the seventh rope used for towing the first buoyant device and the eighth rope used for towing the second buoyant device; and the first anchor device sinking the first tri-directional connecting device and the second tri-directional connecting device under the water surface, and the first turbine power generation device, the second turbine power generation device, the first buoyant device, and the second buoyant device sinking concurrently.

### BRIEF DESCRIPTION OF THE DRAWINGS

FIG. 1 shows a schematic diagram of the structure according to the first embodiment of the present invention;

FIG. 2 shows a schematic diagram of the structure according to the second embodiment of the present invention;

FIG. 3 shows a schematic diagram of the first buoyant device and the second buoyant device according to the present invention;

FIG. 4 shows a flowchart of the deployment method according to the first embodiment of the present invention;

FIG. 5 shows a flowchart of the deployment method according to the second embodiment of the present invention;

FIG. 6 shows a schematic diagram of the structure according to the third embodiment of the present invention; and

FIG. 7 shows a flowchart of the deployment method according to the third embodiment of the present invention.

### DETAILED DESCRIPTION

In the ocean-current power generation technologies according to the prior art, the ocean-current power generator must be fixed in the ocean for not being rotated, tilted, or displaced by ocean currents. Nonetheless, the application of anchoring on the sea floor is costly. Consequently, the technologies are not widely adopted. The present invention provides an ocean-current power generation structure and the deployment method. The structure is simple and the deployment method is easy. The structure is applicable to deep sea, shallow sea, or sea areas with stable currents. The time for construction is short and the cost is low.

In the following description, various embodiments of the present invention are described using figures for describing the present invention in detail. Nonetheless, the concepts of the present invention can be embodied by various forms. Those embodiments are not used to limit the scope and range of the present invention.

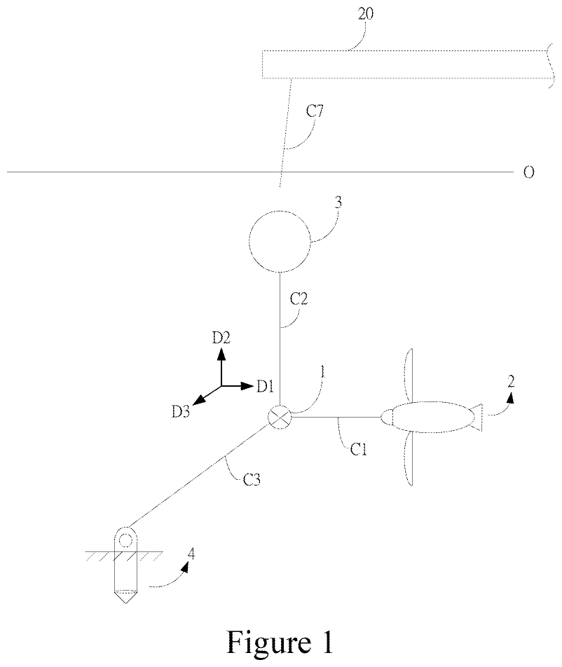

First, please refer to FIG. 1, which shows a schematic diagram of the structure according to the first embodiment of the present invention. The ocean-current power generation structure according to the present invention comprises a first tri-directional connecting device 1, a first turbine power generation device 2, a first buoyant device 3, and a first anchor device 4. The first turbine power generation device 2 is connected to a first direction D1 of the first tri-direction connecting device 1 via a first cable C1. The first buoyant device 3 is connected to a second direction D2 of the first tri-directional connecting device 1 via a second cable C2. The first anchor device 4 is connected to a third direction D3 of the first tri-directional connecting device 1 via a third cable C3.

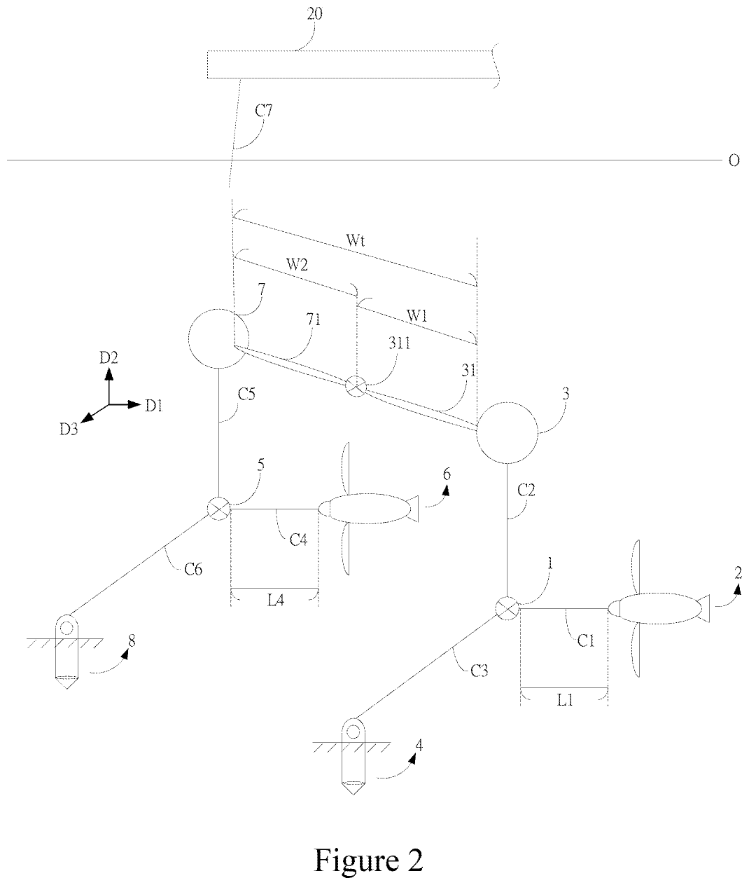

Please refer to FIG. 2, which shows a schematic diagram of the structure according to the second embodiment of the present invention. The ocean-current power generation structure according to the present invention can adopt a plurality of tri-directional connecting devices, turbine power generation devices, buoyant devices, and anchor devices concurrently as the power generation structure. The first buoyant device 3 includes a first rod 31 on one side. A first omnidirectional connecting device 311 is disposed on the other side of the first rod 31. According to the second embodiment, a second tri-directional connecting device 5, a second turbine power generation device 6, a second buoyant device 7, and a second anchor device 8 are used as an example. The ocean-current power generation structure can further comprise a second tri-direction connecting device 5, a second turbine power generation device 6, a second buoyant device 7, and a second anchor device 8. The second turbine power generation device 6 is connected to the first direction D1 of the second tri-directional connecting device 5 via a fourth cable C4. The second buoyant device 7 is connected to the second direction D2 of the second tri-directional connecting device 5 via a fifth cable C5. The second anchor device 8 is connected to the third direction D3 of the second tri-directional connecting device 5 via a sixth cable C6. The second buoyant device 8 includes a second rod 71 on one side. The other side of the second rod 71 is connected to the first omnidirectional connecting device 311.

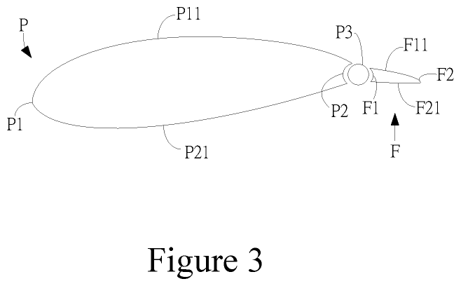

Please refer to FIG. 3, which shows a schematic diagram of the first buoyant device and the second buoyant device according to the present invention. The first buoyant device 3 and the second buoyant device 7 include an accommodating space such that the first buoyant device 3 and the second buoyant device 7 can be buoyant and floating on water. The first buoyant device 3 and the second buoyant device 7 can be selected from the group consisting of, but not limited to, a sphere, a spheroid, and an aerofoil-shaped member P. The aerofoil-shaped member P includes a first front edge P1, a first rear edge P2, a first top curved surface P11, and a first bottom curved surface P21. The first front edge P1 shrinks gradually along the first top curved surface P11 and the first bottom curved surface P21 to the first rear edge P2. In addition, the aerofoil-shaped member P can further include an aileron F, which includes a second front edge F1, a second rear edge F2, a second top curved surface F11, and a second bottom curved surface F21. The second front edge F2 shrinks gradually along the second top curved surface F11 and the second bottom curved surface F21 to the second rear edge F2. The second front edge F1 is connected to the first read edge F2 via a second omnidirectional connecting device P3. The aileron F is used for changing the angle of attack (AOA) of the aerofoil-shaped member P and thus changing the lifting force. Thereby, the first turbine power generation device 2 and the second turbine power generation device 6 can be maintained at the maximum mechanical efficiency. The aerofoil-shaped member P can be another form, not limited to the above examples.

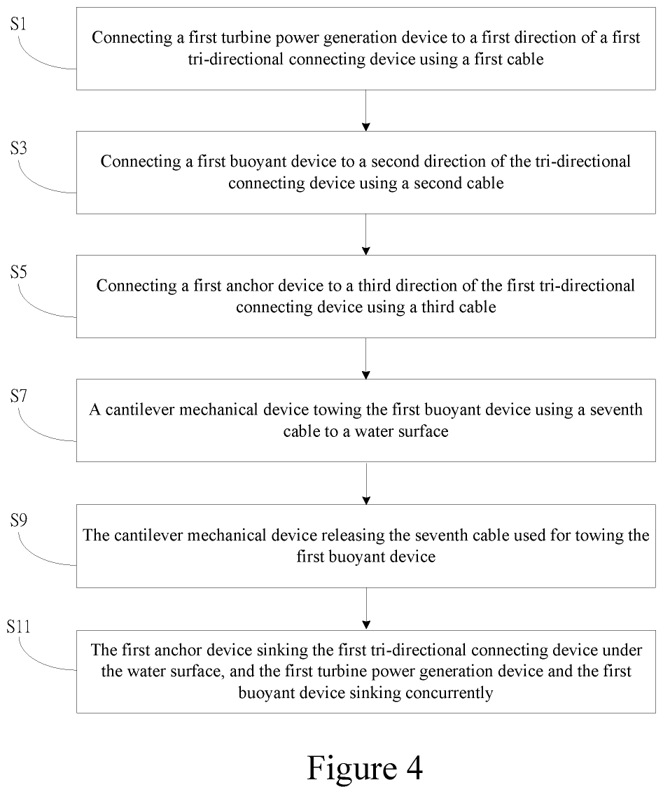

Please refer to FIG. 4, which shows a flowchart of the deployment method according to the first embodiment of the present invention, comprising steps of:
Step S1: Connecting a first turbine power generation device to a first direction of a first tri-directional connecting device using a first cable;
Step S3: Connecting a first buoyant device to a second direction of the tri-directional connecting device using a second cable;
Step S5: Connecting a first anchor device to a third direction of the first tri-directional connecting device using a third cable;
Step S7: A cantilever mechanical device towing the first buoyant device using a seventh cable to a water surface;
Step S9: The cantilever mechanical device releasing the seventh cable used for towing the first buoyant device; and
Step S11: The first anchor device sinking the first tri-directional connecting device under the water surface, and the first turbine power generation device and the first buoyant device sinking concurrently.

As shown in the step S1, a first turbine power generation device 2 is connected to a first direction D1 of a first tri-directional connecting device 1 using a first cable C1. The first cable C1 has a first-cable length L1. Next, as shown in the step S3, a first buoyant device 3 is connected to a second direction D2 of the tri-directional connecting device 1 using a second cable C2. The second cable C2 has a second-cable length L2. Then, as shown in the step S5, a first anchor device 4 is connected to a third direction D3 of the first tri-directional connecting device 1 using a third cable C3. The third cable C3 has a third-cable length L3.

As shown in the step S7, a cantilever mechanical device tows the first buoyant device 3 using a seventh cable C7 to a water surface. Next, as shown in the step S9, the cantilever mechanical device releases the seventh cable C7 used for towing the first buoyant device 3. Finally, as shown in the step S11, due to the weight of the first anchor device 4, the first tri-directional connecting device 1 sinks under the water surface O. After pulling and dragging by the first tri-directional connecting device 1, the first turbine power generation device 2 and the first buoyant device 3 connected concurrently to the first tri-directional connecting device 1 will sink under the water surface O at the same time. After the first anchor device 4 stays on the seabed, the first turbine power generation device 2, the first buoyant device 3, and the first anchor device 4 will exhibit force equilibrium under the water surface O.

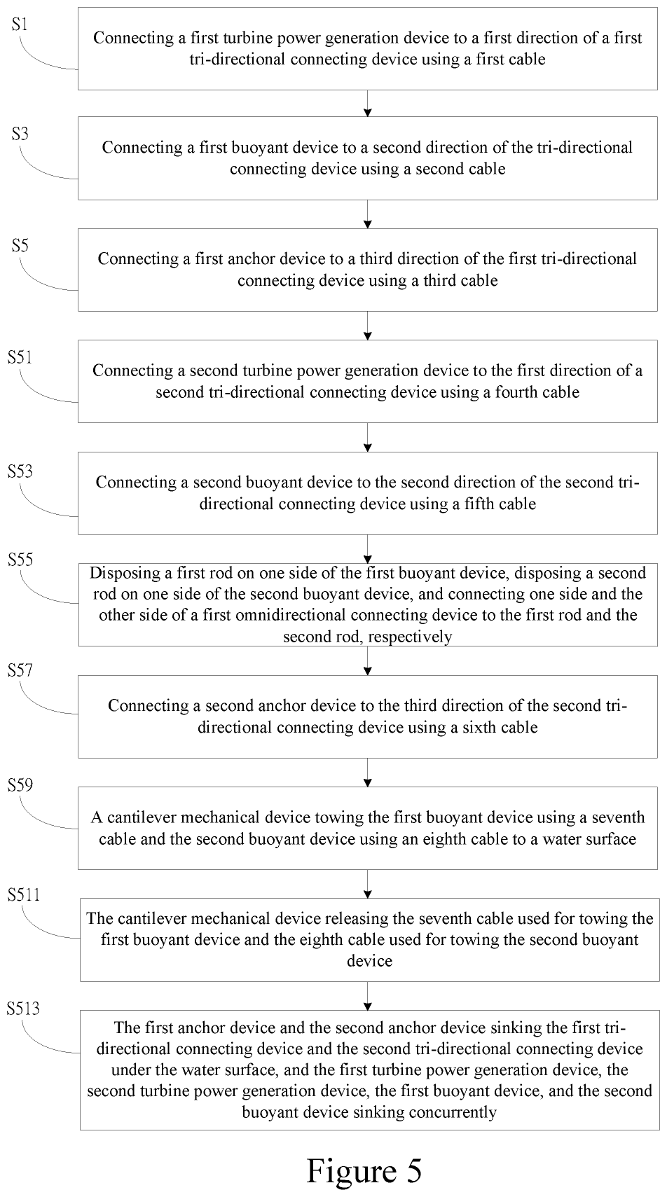

Please refer to FIG. 5, which shows a flowchart of the deployment method according to the second embodiment of the present invention. The present embodiment adopts two tri-directional connecting devices, turbine power generation devices, anchor devices, and buoyant devices as the ocean-current power generation structure. The present invention is not limited to the embodiment. Thereby, after the step S5, the deployment method further comprises steps of:
Step S51: Connecting a second turbine power generation device to the first direction of a second tri-directional connecting device using a fourth cable;
Step S53: Connecting a second buoyant device to the second direction of the second tri-directional connecting device using a fifth cable;
Step S55: Disposing a first rod on one side of the first buoyant device, disposing a second rod on one side of the second buoyant device, and connecting one side and the other side of a first omnidirectional connecting device to the first rod and the second rod, respectively;
Step S57: Connecting a second anchor device to the third direction of the second tri-directional connecting device using a sixth cable;
Step S59: A cantilever mechanical device towing the first buoyant device using a seventh cable and the second buoyant device using an eighth cable to a water surface;
Step S511: The cantilever mechanical device releasing the seventh cable used for towing the first buoyant device and the eighth cable used for towing the second buoyant device; and
Step S513: The first anchor device and the second anchor device sinking the first tri-directional connecting device and the second tri-directional connecting device under the water surface, and the first turbine power generation device, the second turbine power generation device, the first buoyant device, and the second buoyant device sinking concurrently.

As shown in the step S51, a second turbine power generation device 6 is connected to the first direction D1 of a second tri-directional connecting device 5 using a fourth cable C4. The fourth cable C4 has a fourth-cable length L4. Next, as shown in the step S53, a second buoyant device 7 is connected to the second direction D2 of the second tri-directional connecting device 5 using a fifth cable C5. Then, as shown in the step S55, dispose a first rod 31 on one side of the first buoyant device 3; dispose a second rod 71 on one side of the second buoyant device 7; and connect one side and the other side of a first omnidirectional connecting device 311 to the first rod 31 and the second rod 71, respectively. The first rod 31 has a first-rod length W1; the second rod 71 has a second-rod length W2.

Because the first rod 31 and the second rod 71 are connected by the first omnidirectional device 311, the first rod 31 and the second rod 71 can bend to some extent, making the spacing between the first buoyant device 3 and the second buoyant device 7 be Wt, which is approximately the sum of the first-rod length W1 and the second-rod length W2. Hence, the first buoyant device 3 and the second buoyant device 7 will not collide. In addition, to avoid collision between the first turbine power generation device 2 and the second turbine power generation device 6 caused by ocean currents, the first-cable length L1 of the first cable C1 and the fourth-cable length L4 of the fourth cable C4 must be significantly smaller than the spacing Wt. According to a preferred embodiment of the present invention, the spacing Wt is greater than at least four times the first-cable length L1. Likewise, the spacing Wt is greater than at least four times the fourth-cable length L4. Next, as shown in the step S57, a second anchor device 8 is connected to the third direction D3 of the second tri-directional connecting device 5 using a sixth cable C6.

As shown in the step S59, a cantilever mechanical device tows the first buoyant device 3 using a seventh cable C7 and the second buoyant device 7 using an eighth cable C8 to a water surface. Next, as shown in the step S511, the cantilever mechanical device releases the seventh cable C7 used for towing the first buoyant device 3 and the eighth cable C8 used for towing the second buoyant device 7. Finally, as shown in the step S513, due to the weights of the first anchor device 4 and the second anchor device 9, the first tri-directional connecting device 1 and the second tri-directional connecting device 5 sink under the water surface O. After pulling and dragging by the first tri-directional connecting device 1 and the second tri-directional connecting device 5, the first turbine power generation device 2 and the first buoyant device 3 connected concurrently to the first tri-directional connecting device 1 and the second turbine power generation device 6 and the second buoyant device 7 connected concurrently to the second tri-directional connecting device 2 will sink under the water surface O at the same time. After the first anchor device 4 and the second anchor device 8 stay on the seabed, the first turbine power generation device 2, the first buoyant device 3, the second turbine power generation device 6, the second buoyant device 7, the first anchor device 4, and the second anchor device 8 will exhibit force equilibrium under the water surface O.

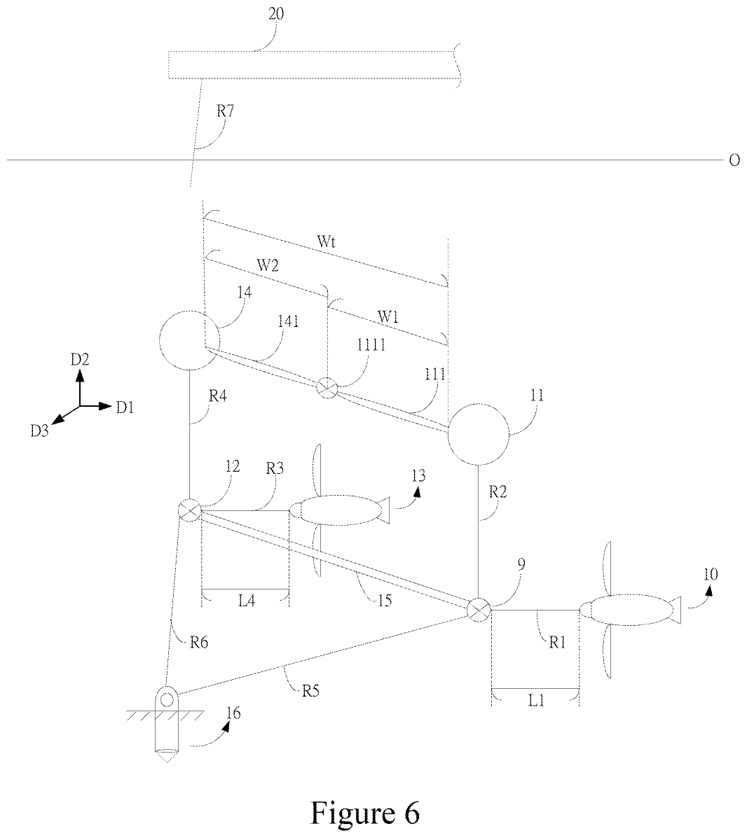

Please refer to FIG. 6, which shows a schematic diagram of the structure according to the third embodiment of the present invention. The difference between the present embodiment and the previous one is that the present embodiment adopts a plurality of tri-directional connecting devices, turbine power generation devices, and buoyant devices but only one anchor device concurrently for lowering the construction cost. According to the present embodiment, two tri-directional connecting devices, turbine power generation devices, and buoyant devices and one anchor device are used as an example. Nonetheless, the present invention is not limited to the present embodiment.

The ocean-current power generation structure according to the present embodiment comprises a first tri-directional connecting device 9, a first turbine power generation device 10, a first buoyant device 11, a second tri-directional connecting device 12, a second turbine power generation device 13, a second buoyant device 14, a third rod 15, and a first anchor device 16. The first turbine power generation device 10 is connected to a first direction D1 of the first tri-directional connecting device 9 via a first rope R1. The first buoyant device 11 is connected to a second direction D2 of the first tri-directional connecting device 9 via a second rope R2. The second turbine power generation device 13 is connected to the first direction D1 of the second tri-directional connecting device 12 via a third rope R3. The second buoyant device 14 is connected to the second direction D2 of the second tri-directional connecting device 12 via a fourth rope R4. One side of the third rod 15 is connected to the first tri-directional connecting device 9. The other side of the third rod 15 is connected to the second tri-directional connecting device 12. The first anchor device 6 is connected to the first tri-directional connecting device 9 and a third direction D3 of the second tri-directional connecting device 12 via a fifth rope R5 and a sixth rope R6. The first buoyant device 11 includes a first rod 111 on one side. The other side of the first rod 111 is connected to a first omnidirectional connecting device 1111. The second buoyant device 14 includes a second rod 141 on one side. The other side of the second rod 141 is connected to the first omnidirectional connecting device 1111. The first buoyant device 11 and the second buoyant device 14 are identical to the ones described in the previous embodiment. Hence, the details will not be repeated.

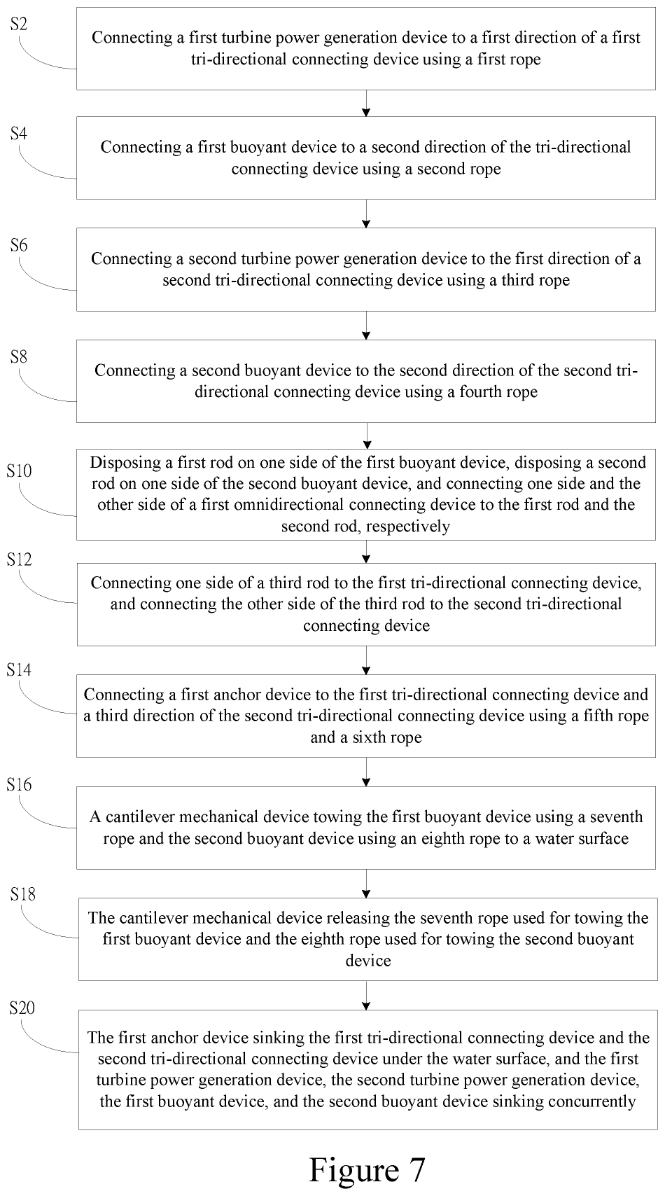

Please refer to FIG. 7, which shows a flowchart of the deployment method according to the third embodiment of the present invention. The difference between the present embodiment and the previous one is that the present embodiment adopts a plurality of tri-directional connecting devices, turbine power generation devices, and buoyant devices but only one anchor device concurrently for lowering the construction cost. According to the present embodiment, two tri-directional connecting devices, turbine power generation devices, and buoyant devices and one anchor device are used as an example. Nonetheless, the present invention is not limited to the present embodiment. The present embodiment comprises steps of:
Step S2: Connecting a first turbine power generation device to a first direction of a first tri-directional connecting device using a first rope;
Step S4: Connecting a first buoyant device to a second direction of the tri-directional connecting device using a second rope;
Step S6: Connecting a second turbine power generation device to the first direction of a second tri-directional connecting device using a third rope;
Step S8: Connecting a second buoyant device to the second direction of the second tri-directional connecting device using a fourth rope;
Step S10: Disposing a first rod on one side of the first buoyant device, disposing a second rod on one side of the second buoyant device, and connecting one side and the other side of a first omnidirectional connecting device to the first rod and the second rod, respectively;
Step S12: Connecting one side of a third rod to the first tri-directional connecting device, and connecting the other side of the third rod to the second tri-directional connecting device;
Step S14: Connecting a first anchor device to the first tri-directional connecting device and a third direction of the second tri-directional connecting device using a fifth rope and a sixth rope;
Step S16: A cantilever mechanical device towing the first buoyant device using a seventh rope and the second buoyant device using an eighth rope to a water surface;
Step S18: The cantilever mechanical device releasing the seventh rope used for towing the first buoyant device and the eighth rope used for towing the second buoyant device; and
Step S20: The first anchor device sinking the first tri-directional connecting device and the second tri-directional connecting device under the water surface, and the first turbine power generation device, the second turbine power generation device, the first buoyant device, and the second buoyant device sinking concurrently.

As shown in the step S2, a first turbine power generation device 10 is connected to a first direction D1 of a first tri-directional connecting device 9 using a first rope R1. The first rope R1 has a first-rope length X1. Next, as shown in the step S4, a first buoyant device 11 is connected to a second direction D2 of the tri-directional connecting device 9 using a second rope R2. Then, as shown in the step S6, a second turbine power generation device 13 is connected to the first direction D1 of a second tri-directional connecting device 12 using a third rope R3. The third rope R3 has a third-rope length X3. Next, as shown in the step S8, a second buoyant device 14 is connected to the second direction D2 of the second tri-directional connecting device 12 using a fourth rope R4.

As shown in the step S10, dispose a first rod 111 on one side of the first buoyant device 11; dispose a second rod 141 on one side of the second buoyant device 14; and connect one side and the other side of a first omnidirectional connecting device 1111 to the first rod 111 and the second rod 141, respectively. The first rod 111 has a first-rod length Y1; the second rod 141 has a second-rod length Y2. Next, as shown in the step S12, one side of a third rod 15 is connected to the first tri-directional connecting device 9 and the other side of the third rod 15 is connected to the second tri-directional connecting device 12. Then, as shown in the step S14, a first anchor device 16 is connected to the first tri-directional connecting device 9 and a third direction D3 of the second tri-directional connecting device 12 using a fifth rope R5 and a sixth rope R6.

Because the first rod 111 and the second rod 141 are connected by the first omnidirectional device 1111, the first rod 111 and the second rod 141 can bend to some extent, making the spacing between the first buoyant device 11 and the second buoyant device 14 be Yt, which is approximately the sum of the first-rod length Y1 and the second-rod length Y2. Hence, the first buoyant device 11 and the second buoyant device 14 will not collide. In addition, to avoid collision between the first turbine power generation device 10 and the second turbine power generation device 13 caused by ocean currents, the first-rope length X1 of the first rope R1 and the third-rope length X3 of the third rope R3 must be significantly smaller than the spacing Yt. According to a preferred embodiment of the present invention, the spacing Yt is greater than at least four times the first-rope length X1. Likewise, the spacing Yt is greater than at least four times the third-rope length X3.

As shown in the step S16, a cantilever mechanical device tows the first buoyant device 11 using a seventh rope R7 and the second buoyant device 14 using an eighth rope R8 to a water surface. Next, as shown in the step S18, the cantilever mechanical device releases the seventh rope R7 used for towing the first buoyant device 11 and the eighth rope R8 used for towing the second buoyant device 14. Finally, as shown in the step S20, due to the weight of the first anchor device 16, the first tri-directional connecting device 9 and the second tri-directional connecting device 12 sink under the water surface O. After pulling and dragging by the first tri-directional connecting device 9 and the second tri-directional connecting device 12, the first turbine power generation device 10 and the first buoyant device 111 connected concurrently to the first tri-directional connecting device 9 and the second turbine power generation device 13 and the second buoyant device 14 connected concurrently to the second tri-directional connecting device 12 will sink under the water surface O at the same time. The first turbine power generation device 10, the first buoyant device 11, the second turbine power generation device 13, the second buoyant device 14, and the first anchor device 16 will exhibit force equilibrium under the water surface O.

According to the above embodiments, the ocean-current power generation structure and the deployment method according to the present invention adopt tri-directional connecting devices, turbine power generation devices, buoyant devices, and anchor devices as the power generation structure. The structure is simple and the deployment method is easy, enabling rapid construction and deployment to deep sea, shallow sea, or sea areas with stable currents. In addition, a plurality of tri-directional connecting devices, turbine power generation devices, buoyant devices, and anchor devices can be adopted concurrently. By using a plurality of rods for connecting a plurality of devices or by adopting a plurality of tri-directional connecting devices, turbine power generation devices, buoyant devices, and only a single anchor device, the number of anchor devices can be reduced and thus lowering the construction cost.

1. An ocean-current power generation structure, comprising:
a first tri-directional connecting device;
a first turbine power generation device, connected to a first direction of said first tri-direction connecting device via a first cable;
a first buoyant device, connected to a second direction of said first tri-directional connecting device via a second cable, said second direction of said first tri-directional connecting device directed to an upper side of said first tri-directional connecting device; and
a first anchor device, connected to a third direction of said first tri-directional connecting device via a third cable, said first turbine power generation device located between said first buoyant device and said first anchor device.

2. The ocean-current power generation structure of claim 1, wherein said first buoyant device includes a first rod on one side; and a first omnidirectional connecting device is connected to the other side of said first rod.

3. The ocean-current power generation structure of claim 2, and further comprising:
a second tri-direction connecting device,
a second turbine power generation device, connected to said first direction of said second tri-directional connecting device via a fourth cable;
a second buoyant device, connected to said second direction of said second tri-directional connecting device via a fifth cable, including a second rod on one side of said second buoyant device, and the other side of said second rod connected to said first omnidirectional connecting device, said second direction of said second tri-directional connecting device directed to an upper side of said second tri-directional connecting device; and
a second anchor device, connected to said third direction of said second tri-directional connecting device via a sixth cable, said second turbine power generation device located between said second buoyant device and said second anchor device.

4. The ocean-current power generation structure of claim 1, wherein said first buoyant device and a second buoyant device include an accommodating space such that said first buoyant device and said second buoyant device can be buoyant and floating on water; said first buoyant device and said second buoyant device are selected from the group consisting of a sphere, a spheroid, and an aerofoil-shaped member.

5. The ocean-current power generation structure of claim 4, wherein said aerofoil-shaped member includes a first front edge, a first rear edge, a first top curved surface, and a first bottom curved surface; and said first front edge shrinks gradually along said first top curved surface and said first bottom curved surface to said first rear edge.

6. The ocean-current power generation structure of claim 5, wherein said aerofoil-shaped member can further include an aileron; said aileron includes a second front edge, a second rear edge, a second top curved surface, and a second bottom curved surface; said second front edge shrinks gradually along said second top curved surface and said second bottom curved surface to said second rear edge; and said second front edge is connected to said first read edge via a second omnidirectional connecting device.

7. A deployment method for ocean-current power generation structure, comprising steps of:
connecting a first turbine power generation device to a first direction of a first tri-directional connecting device using a first cable;
connecting a first buoyant device to a second direction of said tri-directional connecting device using a second cable;
connecting a first anchor device to a third direction of said first tri-directional connecting device using a third cable;
a cantilever mechanical device moving said first buoyant device using a seventh cable to a water surface;
said cantilever mechanical device releasing said seventh cable used for moving said first buoyant device; and
said first anchor device sinking said first tri-directional connecting device under said water surface, said second direction of said first tri-directional connecting device directed to an upper side of said first tri-directional connecting device and said water surface, and said first turbine power generation device and said first buoyant device sinking concurrently, said first turbine power generation device located between said first buoyant device and said first anchor device.

8. The deployment method for ocean-current power generation structure of claim 7, and after said step of connecting a first anchor device to a third direction of said first tri-directional connecting device using a third cable, further comprising steps of:
connecting a second turbine power generation device to said first direction of a second tri-directional connecting device using a fourth cable;
connecting a second buoyant device to said second direction of said second tri-directional connecting device using a fifth cable;
disposing a first rod on one side of said first buoyant device, disposing a second rod on one side of said second buoyant device, and connecting one side and the other side of a first omnidirectional connecting device to said first rod and said second rod, respectively;
connecting a second anchor device to said third direction of said second tri-directional connecting device using a sixth cable;
said cantilever mechanical device moving said first buoyant device using a seventh cable and said second buoyant device using an eighth cable to said water surface;
said cantilever mechanical device releasing said seventh cable used for moving said first buoyant device and said eighth cable used for towing said second buoyant device; and
said first anchor device and said second anchor device sinking said first tri-directional connecting device and said second tri-directional connecting device under said water surface, said second direction of said second tri-directional connecting device directed to said water surface, and said first turbine power generation device, said second turbine power generation device, said first buoyant device, and said second buoyant device sinking concurrently, said second turbine power generation device located between said second buoyant device and said second anchor device.

9. An ocean-current power generation structure, comprising:
a first tri-directional connecting device,
a first turbine power generation device, connected to a first direction of said first tri-directional connecting device via a first rope;
a first buoyant device, connected to a second direction of said first tri-directional connecting device via a second rope, including a first rod on one side, and the other side of said first rod connected to a first omnidirectional connecting device, said second direction of said first tri-directional connecting device directed to an upper side of said first tri-directional connecting device;
a second tri-directional connecting device,
a second turbine power generation device, connected to said first direction of said second tri-directional connecting device via a third rope;
a second buoyant device, connected to said second direction of said second tri-directional connecting device via a fourth rope, including a second rod on one side, the other side of said second rod connected to said first omnidirectional connecting device, said second direction of said second tri-directional connecting device directed to an upper side of said second tri-directional connecting device;
a third rod, one side of said third rod connected to said first tri-directional connecting device, the other side of said third rod connected to said second tri-directional connecting device; and
a first anchor device, connected to said first tri-directional connecting device and a third direction of said second tri-directional connecting device via a fifth rope and a sixth rope, said first turbine power generation device located between said first buoyant device and said first anchor device, said second turbine power generation device located between said second buoyant device and said first anchor device.

10. The ocean-current power generation structure of claim 9, wherein said first buoyant device and said second buoyant device include an accommodating space such that said first buoyant device and said second buoyant device are buoyant and floating on water; said first buoyant device and said second buoyant device can be selected from the group consisting of a sphere, a spheroid, and an aerofoil-shaped member.

11. The ocean-current power generation structure of claim 10, wherein said aerofoil-shaped member includes a first front edge, a first rear edge, a first top curved surface, and a first bottom curved surface; and said first front edge shrinks gradually along said first top curved surface and said first bottom curved surface to said first rear edge.

12. The ocean-current power generation structure of claim 11, wherein said aerofoil-shaped member can further include an aileron; said aileron includes a second front edge, a second rear edge, a second top curved surface, and a second bottom curved surface; said second front edge shrinks gradually along said second top curved surface and said second bottom curved surface to said second rear edge; and said second front edge is connected to said first read edge via a second omnidirectional connecting device.

13. A deployment method for ocean-current power generation structure, comprising steps of:
connecting a first turbine power generation device to a first direction of a first tri-directional connecting device using a first rope;
connecting a first buoyant device to a second direction of said tri-directional connecting device using a second rope;
connecting a second turbine power generation device to said first direction of a second tri-directional connecting device using a third rope;
connecting a second buoyant device to said second direction of said second tri-directional connecting device using a fourth rope;
disposing a first rod on one side of said first buoyant device, disposing a second rod on one side of said second buoyant device, and connecting one side and the other side of a first omnidirectional connecting device to said first rod and said second rod, respectively;
connecting one side of a third rod to said first tri-directional connecting device, and connecting the other side of said third rod to said second tri-directional connecting device;
connecting a first anchor device to said first tri-directional connecting device and a third direction of said second tri-directional connecting device using a fifth rope and a sixth rope;
a cantilever mechanical device moving said first buoyant device using a seventh rope and said second buoyant device using an eighth rope to a water surface;
said cantilever mechanical device releasing said seventh rope used for moving said first buoyant device and said eighth rope used for moving said second buoyant device; and
said first anchor device sinking said first tri-directional connecting device and said second tri-directional connecting device under said water surface, said second direction of said first tri-directional connecting device directed to an upper side of said first tri-directional connecting device and said water surface, said second direction of said second tri-directional connecting device directed to an upper side of said second tri-directional connecting device and said water surface, and said first turbine power generation device, said second turbine power generation device, said first buoyant device, and said second buoyant device sinking concurrently, said first turbine power generation device located between said first buoyant device and said first anchor device, said second turbine power generation device located between said second buoyant device and said first anchor device.
